(19) United States
(12) Patent Application Publication
(10) Pub. No.: US 2004/0243384 A1
(43) Pub. Date: Dec. 2, 2004

(54) Complete graph interconnect structure for the hardware emulator

(76) Inventors: Nang-Ping Chen, Cupertino, CA (US); Wei-Hsin Chou, Cupertino, CA (US)

Correspondence Address: Nang-Ping Chen, 21850 Lomita Ave., Cupertino, CA, 95014, US

(21) Appl. No.: 10/680,444

(22) Filed: Oct. 7, 2003

Related U.S. Application Data
(60) Provisional application No. 60/417,652, filed on Oct. 10, 2002.

(51) Int. Cl. G06F 9/455

(52) U.S. Cl. 703/23

(57) ABSTRACT

A “complete graph” interconnect structure for a hardware emulator for reducing the required programmable interconnect resource in the emulator and using the saved resource to increase the utilization of reconfigurable logic devices, such as field programmable gate arrays (FPGAs), in the emulator and therefore increasing emulator capacity. The device includes a plurality of field programmable gate array devices (FPGAs) having logic and interconnect elements which can be reconfigured for different functions; a “complete graph” interconnect structure having wires connecting all FPGAs together similar to a complete graph and having approximately equal number of wires between any pair of FPGAs; emulation software running on the host computer providing partitioning, routing, the interface to the user and the third party electronic design software, testing and debugging functions; and the support circuit having the downloading, debugging, and testing functions. Any of these signal connecting any pair of FPGAs can be routed with one of the direct connections between the pair of FPGAs on the “complete graph” interconnect structure. Most of the remaining signals can be routed with the one-FPGA route-through paths.

### CROSS REFERENCE TO RELATED APPLICATION

This application claims the benefit of provisional United States Patent Application entitled “‘Complete Graph’ Interconnect Structure for the Hardware Emulator,” application No. 60/417,652, filed on Oct. 10, 2002.

### FIELD OF THE INVENTION

The present invention relates generally to a hardware emulator and more specifically it relates to a “complete graph” interconnect structure for the hardware emulator.

### BACKGROUND ART

The hardware emulator has been in use for years. Typically, a hardware emulator is comprised of field programmable gate array device (FPGA) based hardware emulation/prototyping/co-simulation systems (emulator) for the electronic circuit or system and may be built with the “partial crossbar” (detailed in U.S. Pat. No. 5,036,473) or “nearest neighborhood” (detailed in U.S. Pat. No. 5,109,353) interconnect structure.

The main problem with the conventional hardware emulator is that field programmable interconnect devices (FPID) are required to build a “partial crossbar” emulator. Therefore, the emulator is physically large and expensive to build. Because of the abundant options for routing signals crossing the FPGA boundary, the modeling of the electronic circuit or system is easier with a “partial crossbar” emulator than with a “nearest neighborhood” emulator. However, another problem associated with a “partial crossbar” emulator is that any signal path crossing the FPGA boundary has to be routed through at least one FPID; therefore the signal delay is long and the emulator runs slowly.

Another problem with a conventional hardware emulator is that any signal connecting two non-neighboring FPGAs (i.e., no wire between the two FPGAs) has to be routed through one or more intermediate FPGAs in a “nearest neighborhood” emulator. The number of FPGAs to be routed through in connecting two non-neighboring FPGAs will be no less than the number of FPGAs intermediating between the two FPGAs to be connected. The situation gets worse when the signal has to connect more than 2 FPGAs. The signal delays will be long and unpredictable in a “nearest neighborhood” emulator and therefore a “nearest neighborhood” emulator runs even slower than a “partial crossbar” emulator.

Another problem with a conventional hardware emulator is that an unpredictable high number of FPGA pins has to be reserved as route-through paths for foreign signals connecting non-neighboring FPGAs in a “nearest neighborhood” emulator. The problem worsens when the emulator has to be built with a high number of FPGAs to emulate today's highly complex electronic circuit or system. Another problem associated with a “nearest neighborhood” emulator is that it is difficult to partition effectively the electronic circuit or system into multiple FPGAs with an unpredictable FPGA pin target and therefore many iterations and long software running time may be required to overcome this unpredictability.

While these devices may be suitable for the particular purpose which they address, they are not as suitable for reducing the required programmable interconnect resource in the emulator and using the saved resource to increase the utilization of field programmable gate arrays and therefore the emulator capacity.

In these respects, the “complete graph” interconnect structure for the hardware emulator according to the present invention substantially departs from the conventional concepts and designs of the prior art and in so doing provides an approach primarily developed for the purpose of reducing the required programmable interconnect resource in the emulator and using the saved resource to increase the utilization of field programmable gate array and therefore the emulator capacity. The other purpose of the invention is for providing a multi-FPGA partition with a calculated, high number of target FPGA pins to achieve high FPGA utilization and therefore high emulator capacity. Another purpose of the invention is minimizing signal delays with the direct interconnect paths to speed up emulation. An additional purpose of the invention is eliminating the field programmable interconnect devices (FPID) to simplify the emulator design and reduce the emulator cost. Another purpose of the invention is reducing the number of software iterations necessary to model the electronic circuit or system to reduce the preparation time for the emulator.

### SUMMARY OF THE INVENTION

The general purpose of the present invention, is to provide a new “complete graph” interconnect structure for a hardware emulator.

To attain this, the present invention generally comprises a plurality of reconfigurable logic devices, such as field programmable gate array devices (FPGAs), having logic and interconnect elements which can be reconfigured for different functions, a “complete graph” interconnect structure having wires connecting all FPGAs together similar to a complete graph and having approximately equal number of wires between any pair of FPGAs; the emulation software running on the host computer providing partitioning, routing, and the interface to the user and the third party electronic design software, testing and debugging functions; and the support circuit having the downloading, debugging and testing functions.

The FPGA is a logic device permitting the realization portion of an electronic circuit or system. It can be reconfigured at will so it is well suited for the emulation, prototyping, co-simulation or execution of an electronic system.

The “complete graph” interconnect structure is characterized by every FPGA having all its connections evenly connected to the rest of FPGAs in the emulator. Therefore, direct connections exist between any pair of FPGAs. When an electronic circuit of the system is partitioned into multiple FPGAs, it will be likely to have signals connecting any pair of FPGAs. Any of these signals connecting any pair of FPGAs can be routed with one of the direct connections between this pair of FPGAs on the “complete graph” interconnect structure. This is an improvement over the “nearest neighborhood” interconnect structure, which has no direct connections to route signals between non-neighboring pair of FPGAs. Many of these signals connecting pairs of FPGAs can be routed with the direct connections in the “complete graph” interconnect structure and therefore the required programmable interconnect resource in the emulator is greatly reduced.

Most of the remaining signals can be routed with the one-FPGA route-through paths on the “complete graph” interconnect structure which has no fewer routing options than the “partial crossbar” interconnect structure. This is an improvement over the “partial crossbar” interconnect structure, which requires the programmable interconnects to make connections for every signal and therefore the emulator requires excessive programmable interconnect resource.

A timing critical signal between any pair of FPGAs can be routed with a direct connection on the “complete graph” interconnect structure. This is not possible in the “nearest neighbor” or “partial crossbar” interconnect structures.

The emulation software will model the emulated design with multiple FPGAs and the “complete graph” interconnect structure. The emulation software may also perform the testing and debugging functions in some emulators. The emulation software imports the emulated design created by other third party tools, partitions the design into multiple FPGAs, routes the signals crossing the FPGA boundary on the “complete graph” interconnect structure, exports the result to be further processed by FPGA place-and-route software, collects the debugging information from the emulator, and interfaces to the other third party tools. A user interface is also included in the software.

A support circuit includes the rest of the emulator hardware not necessary for modeling the emulated design. The support circuit performs various functions such as downloading, debugging, and testing.

The “complete graph” interconnect structure for the hardware emulator emulates bigger designs with reduction in the required programmable interconnect resource and uses the saved resource to increase the FPGA utilization.

The “complete graph” interconnect structure for the hardware emulator that runs faster by routing the timing-critical signals through the direct interconnect paths to reduce delays. The direct interconnect paths exist between any pair of FPGAs without the neighborhood constraint as in the “nearest neighborhood” emulator and eliminate the mandatory FPIDs inserted in all signal paths as in the “partial crossbar” emulator.

The “complete graph” interconnect structure for the hardware emulator runs as fast as the “partial crossbar” emulator in the worst cases by providing one-FPGA route-through paths as in the “partial crossbar” emulator for those remaining signals that have no available direct interconnect paths.

The “complete graph” interconnect structure for the hardware emulator is compact in size and, by eliminating FPIDs in the emulator such as in the “partial crossbar” emulator, cheaper.

The “complete graph” interconnect structure for the hardware emulator makes modeling the electronic circuit and system by software easier and faster by enabling the effective partition of the electronic circuit or system into multiple FPGAs with a calculated, high number of FPGA pins.

### BRIEF DESCRIPTION OF THE DRAWINGS

FIG. 1 is a block diagram of the emulation system of the present invention.

FIG. 2 is a block diagram showing the FPGA usage in the present invention.

FIG. 3 is a block diagram of the interconnect structure of the present invention.

FIG. 4 is a flow chart showing software operations in the present invention.

### DETAILED DESCRIPTION OF THE INVENTION

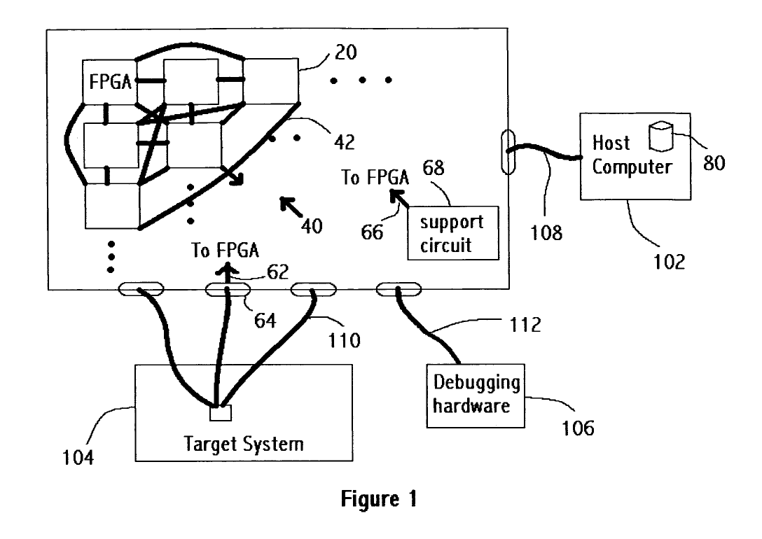

Referring to FIG. 1, the hardware emulator features a plurality of reconfigurable logic devices, in this embodiment field programmable gate array devices (FPGAs), 20 having logic and interconnect elements which can be reconfigured for different functions, a “complete-graph interconnect structure” 40 having wires 42 connecting all FPGAs together similar to a complete graph and having approximately equal number of wires between any pair of FPGAs, the emulation software 80 running on the host computer 102 providing partitioning, routing, the interface to the user and the third party electronic design software, testing, and debugging functions, and the support circuit 68 providing downloading, debugging, and testing functions.

One possible embodiment of the invention would feature 8 Xilinx Virtex-II 6000 FPGAs having about 1100 pins. There would be about 140 pins between each FPGA pair, with the remaining pins used for connecting to a target system or host computer, global lines, and/or debugging lines. Other types of devices and different numbers of pins can be used in other embodiments.

The FPGA 20 is a logic device permitting the realization portion of an electronic circuit or system. It can be reconfigured at will so it is well suited for the emulation, prototyping, co-simulation, or execution of an electronic system. The “complete graph” interconnect structure 40 is characterized by every FPGA 20 having all its connections evenly connected to the rest of FPGAs 20 in the emulator. Therefore, the direct connections 42 exist between any pair of FPGAs. When an electronic circuit of system is partitioned into multiple FPGAs 20, it will be likely to have signals connecting any pair of FPGAs. Any of these signals connecting any pair of FPGAs can be routed with one of the direct connections 42 between this pair of FPGAs on the “complete graph” interconnect structure 40.

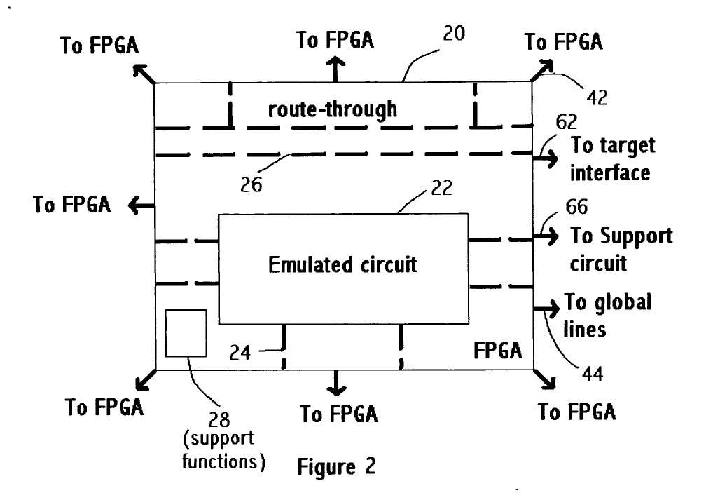

Referring to FIG. 2, most of the remaining signals can be routed with the one-FPGA route-through paths 26 on the “complete graph” interconnect structure which has no fewer routing options than the “partial crossbar” interconnect structure. A timing critical signal between any pair of FPGAs can be routed with a direct connection on the “complete graph” interconnect structure; this is not possible in the “nearest neighbor” or “partial crossbar” interconnect structures.

With reference to FIG. 1, the emulation software 80 will model the emulated design with multiple FPGAs and the “complete graph” interconnect structure. It may also perform the testing and debugging functions in some emulators. The emulation software 80 imports the emulated design created by other third party tools, partitions the design into multiple FPGA's routes the signals crossing the FPGA boundary on the “complete graph” interconnect structure, exports the result to be further processed by FPGA place-and-route software, collects the debugging information from the emulator and interfaces to the other third party tools. A user interface is also included in the software.

The support circuit 68 includes the rest of the emulator hardware not for the purpose of modeling the emulated design. The support circuit performs various functions such as downloading, transmitting debugging data, and testing.

Referring to FIG. 2, the FPGA 20 is a reconfigurable logic device with abundant resources of combinatorial gates, flip-flops, memories, IP structures necessary to model a portion of an electronic circuit or system 22. The FPGA 20 is also used to implement route-through paths 26 for foreign signals. Many commercially available FPGAs 20 are well-suited for this purpose. Every FPGA 20 is evenly connected to every other FPGA 20 through wires 42 in the “complete graph” interconnect structure.

In FIG. 1, the electronic circuit or system is modeled by this group of FPGAs 20 in a “complete graph” interconnect structure. There are wires 62 from FPGAs 20 to connectors 64 to be connected to the target system 104. There are wires 66 from the support circuit 68 to FPGAs 20 for downloading, debugging, and testing purposes. With reference to FIG. 2, the FPGA 20 may be used to implement some support functions 28 such as transmitting debugging data and testing. The route-through paths 26 may be used to route signals connecting more than 2 FPGAs 20.

The FPGA 20 may also be connected to global wires 44 which connects all or some of FPGAs 20 to carry global signals such as clocks, reset, etc. Some FPGAs in the emulator may perform special functions such as clock generation, debugging, etc. and are not connected to other FPGAs 20 through the “complete graph” interconnect structure 40. The FPGA 20 may be reconfigurable only once or can be reconfigured multiple times. The FPGA 20 can be of different types. The FPGA 20 may be substituted with the programmable logic device (PLD) or any other reconfigurable logic device with similar features of programmable logic and interconnect elements.

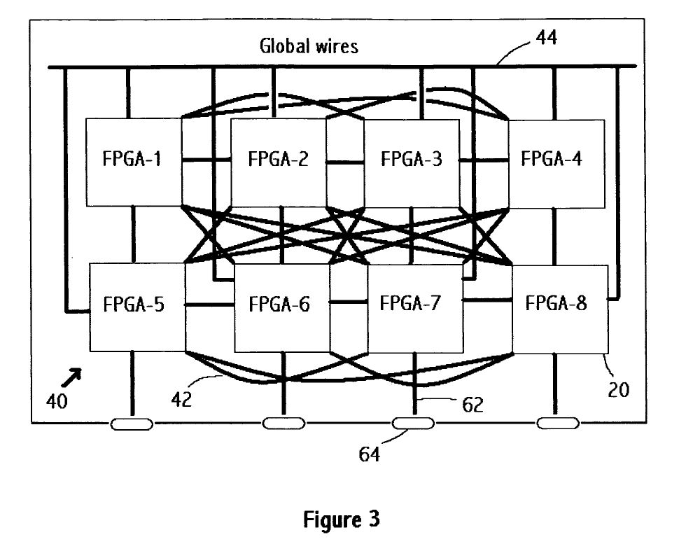

In FIG. 3, the “complete graph” interconnect structure 40 is characterized by every FPGA 20 having all its connections 42 evenly connected to the rest of FPGAs 20 in the emulator. Therefore, the direct connections exist between any pair of FPGAs 20. When an electronic circuit of system is partitioned into multiple FPGAs 20, it will be likely to have signals connecting pairs of FPGAs. Any of these signals connecting any pair of FPGAs can be routed with one of the direct connections 42 between this pair of FPGAs 20 on the “complete graph” interconnect structure 40.

With reference to FIG. 2, each FPGA 20 has all its wires, excluding those wires used for the global signals 44, debugging, downloading, testing 66 or the target system interface 62 purposes, evenly connected to every other FPGA 20 in the emulator. Each FPGA 20 is used both for emulating a portion of the electronic circuit or system 22 and for the routing 26 of the foreign signals. As an example, in FIG. 3 of the drawings, there are 8 FPGAs in the emulator, each FPGA 20 has 1000 available pins, so the number of wires connecting FPGA-1 to any other FPGA, for example, FPGA-2, is 1000 divided by 7 which is about 143. The number of wires 42 connecting a pair of FPGAs 20 may not be exactly the same in the implementation. The emulator may have wires connecting all or some FPGAs 20 together for the implementation of global signals 44 or the timing critical signals. Some FPGAs 20 in the emulator may perform special functions such as clock generation, debugging, etc. and are not connected to other FPGAs 20 through the “complete graph” interconnect structure 40. A signal may be routed through more than one FPGA 20. In FIG. 1, some FPGAs 20 may have connections 62 to the target system 104 and some FPGAs 20 may not.

The emulator may include devices, such as memory, other than FPGAs to efficiently implement some portion of the design. There will be wires connecting FPGA to these non-FPGA devices. Multiple emulators with the “complete graph” interconnect structure may be connected together to emulate big designs. The emulator may be used for the simulation purpose only in this situation, the emulator is not connected 62 to the target system 104.

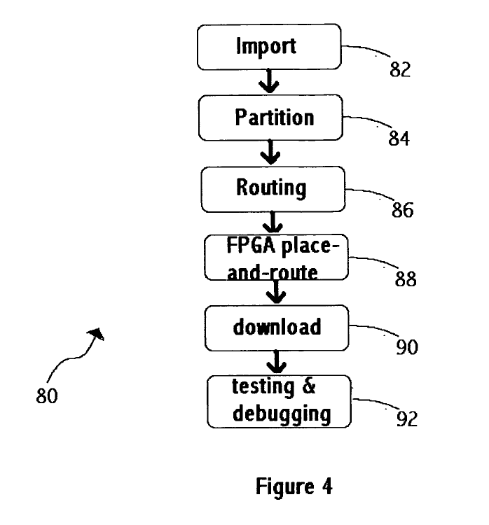

The emulation software will model the emulated design with multiple FPGAs 20, the “complete graph” interconnect structure 40, global wires 44, and target interface wires 62. It also performs the testing and debugging functions in some emulators. The emulation software imports the emulated design created by other third party tools (such as Design compiler from Synopsys), partitions the design into multiple FPGAs, routes the signals crossing the FPGA boundary on the “complete graph” interconnect structure, exports the result to be further processed by FPGA place-and-route software, collects the debugging information from the emulator and interfaces to the other third party tools. A user interface is also included in the software. As shown in FIGS. 1 and 4 of the drawings, the emulation software 80 runs on the host computer 102 which could be a PC or a workstation.

With reference to FIG. 4, the modeling is accomplished by importing 82 the design followed by the partition 84 of the design into multiple FPGAs 20, followed by the routing 86 of the signals crossing the FPGA boundary on the “complete graph” interconnect structure, and then the FPGA place-and-route 88, which generates programming bitstreams to be downloaded 90 to the hardware emulator to configure its FPGAs. The constraints on the timing, target interface, and debugging are set before partition 84.

The emulation software 80 imports 82 the emulated design created by the third party tool through the industry standard formats such as EDIF, Verilog, and VHDL.

The partition software assigns a portion of the design to each FPGA within the limits of the FPGA's available logic and pin capacities so that FPGA place-and-route software can successfully generate its programming bitstream for the FPGA later on. The target FPGA pins are less than the total FPGA pins due to the reservation of a portion of the FPGA pins for the route-through purpose. Due to the “complete graph” interconnect structure which reduces the required route-throughs, a high number target FPGA pins for partition can be determined. The partition software also has to follow the constraints set for the timing, target interface 64 and debugging 66.

In FIG. 2, the routing software connects all signals crossing the FPGA boundary as a result of the partition with the wires 42 in the “complete graph” interconnect structure 40, route-through's 26 in FPGAs 20, global wires 44, and target interface wires 62. The routing software gives high priority to connect the timing-critical signals with the direct interconnect paths between FPGAs to minimize signal delays and therefore speed up the emulation.

After the routing software completes the connections of all signals crossing the FPGA boundary with the wires 42, 62 and 66 and FPGA route-throughs 26, the FPGA place-and-route software can be run on each FPGA 20 with the pin constraints, determined by the routing software, which includes the pins used for the connections 24 to the portion of the emulation circuit 22 and the route-throughs 26 of foreign signals. The FPGA place-and-route software generates the programming bitstreams to configure FPGAs 20 in the emulator.

The emulation software 80 may also perform the testing and debugging tasks in some emulators. The emulator software may interface with the other third party tool such as simulators through the industry standard formats such as EDIF, Verilog, and VHDL to further process the emulation data it collects. A user interface is also included in the software. The design may be described either at the RTL level or at the gate level. A synthesis software is used to generate the gate-level description for the FPGA place-and-route software when the design is at the RTL-level.

The support circuit for the testing and debugging purposes may also be implemented with FPGA and therefore reducing the available FPGA resource for the emulation circuit. Iterations may be necessary for partition, routing and FPGA place-and-route in some situations. If the routing or the FPGA place-and-route failed, partition needs to be re-run with a lowered FPGA resource and pin target. On the other hand, if the routing and FPGA place-and-route has not exhausted all FPGA resources, the partition may be re-run with the higher FPGA resource and pin target to improve on the timing. If a pin-sharing scheme, such as the double data rate feature of the Xilinx VirtexII-6000 FPGA, is adopted to relieve the FPGA pin limits, the target FPGA pins could be even higher than the total FPGA pins.

The support circuit includes the rest of the emulator hardware not used for modeling the emulated design. The support circuit performs various functions such as downloading, debugging, and testing. In FIG. 1, the support circuit 68 is connected 108 with the host computer 102, connected 66 with FPGAs 20 and connected 112 with the external debugging hardware 106. A portion of the support circuit 28 may be implemented inside the FPGAs 20. The support circuit 68 receives the FPGA programming bitstreams generated from the emulation software 80 to download to all the FPGAs 20. The support circuit 68 may be used to transfer the IO and debugging data between the hardware emulator and the emulation software 80. The support circuit 68 may be used to collect and send the debugging data to the external debugging hardware 106. A wide variety of the support circuit 68 functions are implemented in different emulators. The support circuit 68 could simply be used for a download purpose only, or as complicated as a full-blown debugging hardware.

The user has to prepare the target system 104, the connections 110 from the emulator to the target system 104, the connection 108 from the emulator to the host computer 102, and the connection 112 from the emulator to the debugging hardware 106 if any. The software 80 then downloads the FPGA programming bitstreams into the emulator through the support circuit 68 to make it ready for the emulation. When the emulation runs, the debugging and I/O data may be collected by the support circuit 68 and sent to the host computer 102 or the other debugging hardware 106.

The software 80 may be used to manage the debugging data or to interface with other third party tools to further process the data. The target system 104 may not exist if the emulator is used for simulation acceleration instead of in-circuit emulation. The external debugging hardware 106 may also not be required. If the design is at the RTL level, a synthesis software, which could be a third party tool, is required to generate the gate-level description for the FPGA place-and-route software.

Referring to FIG. 2, in the “complete graph” interconnect structure 40, every FPGA 20 has an approximately equal number of wires 42 connected to every other FPGA 20 in the emulator. After the electronic circuit or system is partitioned into multiple FPGAs 20 in the emulator, signals that cross the FPGA 20 boundary have to be routed with these wires 42 and the route-through paths 26 inside FPGAs 20. In one example, a signal connecting from one FPGA 20 to the other FPGA 20 will use a wire 42 between these two FPGAs 20 to make the direct connection if the wire 42 has not been assigned to the other signal, otherwise, the connection has to be made with a route-through path 26 in a third FPGA 20 and the un-assigned wires 42 from the third FPGA 20 to both of these two FPGAs 20. In another example of routine signal connecting more than 2 FPGAs 20, a route-through path in an FPGA 20 together with the unassigned wires 42 between the FPGA and all the FPGAs 20 connected by the signal may be used to complete the connection. In the “complete graph” interconnect structure, the more signals that use the direct connections 42, the less route-throughs 26 (the programming interconnect resource) are required and therefore, the higher number of FPGA pins 24 can be used as the partition target. The partition software will be able to take advantage of this higher target pin count 24 to achieve the higher FPGA 20 utilization and therefore, increase the emulator capacity.

The following is a simplified example illustrating how to calculate the appropriate target FPGA pins 24 for the partition after reserving sufficient FPGAs pins for the route-through 26 purpose in the “complete graph” interconnect structure 40. Assume that all FPGAs are of the same type, all signals crossing FPGA boundaries are connections between 2 FPGAs 20 only, no more than one route-through is required in any signal path, and the global wires 44 and the target system interface 62 are ignored for the illustration purpose.

Define

X=the number of target FPGA pins 24 for the partition,

N=the number of FPGAs 20, in the emulator,

T=the number of pins on each FPGA,

S=total number of signals=X*N/2, with the assumption that all signals are connections between 2 FPGAs 20 only and all target FPGA pins 24 are used,

TW=total number of wires 42 in my invented structure=T*N/2,

P=percentage of signals to be routed with the direct path 42,

DS=total number of signals to be routed with the direct path=P*S,

RS=total number of signals in the system to be routed with the route-throughs=S−DS,

Each route-through requires 2 wires and each direct connect requires 1 wire, so

TW=1*DS+2*RS=1*DS+2*(S−DS)=2*S−DS=2*S−P*S=(2−P)*S=(2−P)*X*N/2,

solved together with the equation TW=T*N/2, we reach the solution X=T/(2−P).

This equation shows that the number of target FPGA pins for the partition (X) will be at least half of the total number of FPGA pins (T/2) because P is a positive number ranging from 0 to 1. This equation also shows that the number of target FPGA pins for the partition (X) will be higher if the higher percentage of signals are routed in direct paths. In one example of an emulator made with Xilinx Virtex-II 6000 FPGAs which have 1100 pins, assuming 75% of signals are routed in direct paths, the number of target FPGA pins for the partition (X)=1100/(2−0.75)=880. If we use the double data rate feature of the Xilinx Virtex-II 6000 FPGA which allows 2 signals under certain conditions to share the same wire, the available FPGA pins will be well over the 1200 that were estimated conservatively in this situation. Even higher target FPGA pins for the partition are possible if the adopted pin sharing scheme allows an even higher number of pins to share the same wire. The emulator will run at a speed comparable to the hard-wired prototype if the timing-critical signals are carefully routed direct paths between FPGA pairs without incurring long delays when the signal is routed through an FPGA.

What is claimed is:

1. A configurable hardware system comprising:
a plurality of reconfigurable logic devices, each of the devices evenly connected to each of the other devices by wires in a complete graph interconnect structure, each of the devices capable of modeling a portion of an electronic circuit or system following configuration by a circuit coupled to the plurality of reconfigurable logic devices, the configuration based on partition of a design of the electronic circuit or system to be emulated and including routing signals crossing each reconfigurable logic device's boundary and assigning pins for each reconfigurable logic device.

2. The system of claim 1 further comprising software running on a host computer coupled to the plurality of reconfigurable logic devices that:
a) imports into the system a design of the electronic circuit or system to be emulated;
b) partitions the design among individual reconfigurable logic devices within the limits of each device's logic and pin capacity, wherein the partition is constrained by a number of target pins for each reconfigurable logic device; and
c) produces a programming bitstream to configure each of the individual reconfigurable logic devices.

3. The system of claim 2 wherein the circuit performs at least one of the following functions:
a) downloading the programming bitstream to configure each of the individual reconfigurable logic devices;
b) transmitting debugging data between the plurality of individual reconfigurable logic devices and the software; and
c) testing the circuit or system emulated by the plurality of individual reconfigurable logic devices.

4. The system of claim 2 further comprising a user interface.

5. The system of claim 1 further comprising each of the reconfigurable logic devices having wires for at least one of the following uses:
a) receiving global signals;
b) transmitting debugging data;
c) downloading;
d) testing; or
e) interfacing with a target system.

6. The system of claim 1 wherein the reconfigurable logic device is a field programmable gate arrary device.

7. The system of claim 2 further comprising the software giving a high priority for directly connecting timing-critical signals between two reconfigurable logic devices.

8. The system of claim 2 wherein the software reserves pins on each reconfigurable logic device for signals between two reconfigurable logic devices which are routed through a third reconfigurable logic device.

9. The system of claim 8 wherein the software partitions the design to achieve a high target pin count for each reconfigurable logic device by routing fewer signals between a pair of reconfigurable devices through a third reconfigurable logic device.

10. The system of claim 1 further comprising a target system coupled to the plurality of reconfigurable logic devices.

11. A configurable hardware system comprising:
a) a plurality of reconfigurable logic devices, each of the devices capable of modeling a portion of an electronic circuit or system, each of the devices evenly connected to each of the other devices by wires in a complete graph interconnect structure;
b) software running on a host computer coupled to the plurality of reconfigurable logic devices that:
i) imports into the system a design of the electronic circuit or system to be emulated;
ii) partitions the design among individual reconfigurable logic devices within the limits of each device's logic and pin capacity, wherein the partition is constrained by a number of target pins for each reconfigurable logic device;
iii) routes signals crossing each reconfigurable logic device's boundary; and
iv) produces a programming bitstream to configure each of the individual reconfigurable logic devices; and
c) a support circuit coupled to the plurality of reconfigurable logic devices, the support circuit performing at least one of the following functions:
i) downloading the programming bitstream from the host computer software to configure each of the individual reconfigurable logic devices;
ii) transmitting debugging data between the plurality of individual reconfigurable logic devices and the host computer software; and
iii) testing the circuit or system emulated by the plurality of individual reconfigurable logic devices.

12. The system of claim 11 further comprising the host computer software performing testing and debugging tasks.

13. The system of claim 11 further comprising a user interface.

14. The system of claim 11 further comprising each of the reconfigurable logic devices having wires for at least one of the following uses:
a) receiving global signals;
b) transmitting debugging data;
c) downloading;
d) testing; or
e) interfacing with a target system.

15. The system of claim 11 wherein the reconfigurable logic device is a field programmable gate array device.

16. The system of claim 11 further comprising the software giving a high priority for directly connecting timing-critical signals between two reconfigurable logic devices.

17. The system of claim 11 wherein the software reserves pins on each reconfigurable logic device for signals between two reconfigurable logic devices which are routed through a third reconfigurable logic device.

18. The system of claim 17 wherein the host computer software partitions the design to achieve a high target pin count for each reconfigurable logic device by routing fewer signals between a pair of reconfigurable logic devices through a third reconfigurable logic device.

19. The system of claim 11 further comprising a target system coupled to the plurality of reconfigurable logic devices.
